(19) United States
(12) Patent Application Publication
(10) Pub. No.: US 2003/0139855 A1
(43) Pub. Date: Jul. 24, 2003

(54) System and method for monitoring an automotive subsystem

(76) Inventors: Werner Hess, Stuttgart (DE); Klaus Ries-Mueller, Rappenau (DE)

Correspondence Address: KENYON & KENYON, ONE BROADWAY, NEW YORK, NY, 10004, US

(21) Appl. No.: 10/220,537

(22) PCT Filed: Dec. 21, 2001
(86) PCT No.: PCT/DE01/04861

(30) Foreign Application Priority Data
Dec. 30, 2000 (DE) 100 65 769.9

(51) Int. Cl. G06F 17/00

(52) U.S. Cl. 701/1; 701/69

(57) ABSTRACT

A system for monitoring a motor vehicle subsystem (42) whereby the vehicle velocity may be influenced includes an evaluation device (14) which determines an actual operating variable of the subsystem (42) according to at least one operating parameter of the vehicle (36) and evaluates the functionality of the subsystem to be monitored (42) on the basis of the determined actual operating variable. It also includes at least one wheel-force sensor device (10) associated with a wheel (12), which detects at least one wheel-force component of the particular wheel (12) acting essentially between the driving surface and the tire contact area as the at least one operating parameter and outputs a signal (Si, Sa) representing the wheel-force component; the evaluation device (14) determines the actual operating variable from the processing of the signal (Si, Sa) which represents the wheel-force component. A corresponding monitoring method is also described.

The present invention relates to a system for monitoring a motor vehicle subsystem by which the vehicle velocity may be influenced, the system including an evaluation device which determines an actual operating variable of the subsystem according to at least one operating parameter of the vehicle and evaluates the functionality of the subsystem being monitored, on the basis of the actual operating variable determined.

In addition, the present invention relates to a method of monitoring a motor vehicle subsystem by which the vehicle velocity may be influenced, preferably to be carried out by a system according to the present invention, where the method includes the following steps: detection of at least one operating parameter of the vehicle, determination of an actual operating variable of the subsystem according to the detected operating parameter of the vehicle, and evaluation of the functionality of the subsystem on the basis of the actual operating variable determined.

### BACKGROUND INFORMATION

Monitoring the drive system of a motor vehicle during operation thereof in regard to correctness of its functioning is known. This is done for example by calculating the drive torque delivered by the engine from engine parameters (for example from the cylinder charge) in an engine control device (for example ME7). Monitoring systems such as the EGAS system compare the delivered engine torque calculated in this way to the torque requested by the driver. If the monitoring system finds discrepancies between the engine torque actually delivered and that requested by the driver, an appropriate measure is carried out in the context of a safety concept; for example, the throttle valve is closed.

A disadvantage of this monitoring system and monitoring method is that the delivered engine torque often may only be determined very imprecisely on the basis of the available engine parameters. As a result, only an inadequate assessment of the functionality of the drive system is possible.

In connection with the sensors provided according to the definition of the species, it is also known that various tire manufacturers plan to use so-called intelligent tires in the future. It will then be possible to position new sensors and evaluation circuits directly on the tire. The use of such tires allows additional functions such as measuring the torque occurring on the tire transversely and longitudinally to the direction of travel, the tire pressure, or the tire temperature. In this connection it is possible for example to provide tires in which magnetized areas or strips are incorporated into each tire, having field lines which preferably run in the circumferential direction. The magnetizing is done for example by sections, always in the same direction but with opposite orientation, i.e., with alternating polarity. Preferably the magnetized strips run close to the wheel rim and close to the contact area. The transducers therefore rotate at the speed of the wheel. Corresponding sensing elements are preferably attached to the body at two or more different points in reference to the direction of rotation, and also are at different radial distances from the axis of rotation. That makes it possible to determine an inner measurement signal and an outer measurement signal. Rotation of the tire can then be recognized from the changing polarity of the measurement signal or signals in the circumferential direction. It is possible to calculate the wheel velocity for example from the extent of roll-off and the change of the inner measurement signal and the outer measurement signal over time.

It has also already been proposed that sensors be placed into the wheel bearing; they may be placed into either the rotating or the static part of the wheel bearing. For example, the sensors can be implemented as microsensors in the form of microswitch arrays. The sensors located on the movable part of the wheel bearing for example measure forces and accelerations and the velocity of rotation of a wheel. This data is compared to electronically stored basic patterns or to data from an equivalent or similar microsensor which is attached to the static part of the wheel bearing.

### ADVANTAGES OF THE PRESENT INVENTION

The present invention builds on the generic system in that it includes at least one wheel-force sensor device associated with a wheel of the motor vehicle, the sensor detecting at least one wheel-force component of the respective wheel which acts essentially between the driving surface and the tire contact area and outputting a signal representing the wheel-force component, as well as by the fact that the evaluation device determines the actual operating variable from processing the signal representing the wheel-force component.

Determining a wheel-force component operating essentially between the driving surface and the tire contact area as an operating parameter makes it possible to very precisely determine certain actual operating variables whose details depend on the particular subsystem of the motor vehicle. It is therefore possible, using the system according to the present invention, to monitor subsystems of the motor vehicle for correctness of their functioning more precisely than in the past. Such subsystems may include primarily the drive system and the brake system.

Advantageously, the evaluation device determines, from the at least one wheel-force component detected by the wheel-force sensor device, a wheel torque operating on the particular wheel. With the help of the wheel torque it is possible to monitor among other things the functionality of the drive system and of the brake system with high precision and without great processing effort, since the performance of these subsystems directly affects the torque exerted on the wheel.

The system according to the present invention may be simplified in an advantageous manner by having the at least one detected wheel-force component already be a circumferential wheel-force and/or a wheel torque retarding or accelerating the respective wheel. Through this direct detection, it is possible to eliminate the step of determining a wheel torque mentioned earlier.

Use of a tire sensor device is conceivable for example for detecting the wheel-force component which is important for determining the actual operating variable. Here the wheel variables are detected very close to the location at which they actually occur, so that interfering influences are very largely excluded by down-line components.

It is also possible as an alternative to use a wheel bearing sensor device. This too enables precise detection of the wheel variables without additional corruption by components present between the location of detection and the location of the wheel variables. An advantage of both named sensors in addition is that they also allow wheel rotation speeds to be determined, and thus make it possible to take the vehicle velocity into account when determining the actual operating variable.

Of particular interest, as already indicated, is the monitoring of the drive system of the motor vehicle. This includes for example the engine and any devices which control or regulate the engine. It is advantageous to use as the actual operating variable an engine torque delivered by the engine, which may be determined particularly easily from a wheel-force, in particular from a circumferential wheel-force or the wheel torque.

The accuracy of the calculation of the actual engine torque from the detected wheel-force component or from the detected wheel torque may be improved by having the evaluation device take account of transmission losses of at least one torque transmission device located in the torque transmission path from the engine to the wheel when determining an actual engine torque as the actual operating variable.

For determining the actual engine torque, pre-defined characteristic curves may be stored in the system which indicate a corresponding actual engine torque as a function of a detected wheel-force component or a detected wheel torque, taking additional vehicle parameters such as the velocity into account if appropriate. This manner of determining the actual engine torque theoretically from the wheel-force component or the wheel torque has the advantage that it may be used to determine an actual engine torque very quickly.

To take the vehicle velocity into account, a velocity sensor may be added to the system according to the present invention.

If on the other hand one considers it important to calculate the actual engine torque as precisely as possible, an advantageous refinement the system according to the present invention may include an additional sensor device which detects the transmission losses at the at least one device named above. Such components may include clutch and transmission (including transfer case) may be considered as such devices.

The named determination methods, i.e., a characteristic curve or a sensor device for transmission losses, may also be used in combination, in order to perform a mutual plausibility check of the determined actual engine torques and/or in order to make adaptive adjustment of the characteristic curve possible, which will generate or modify characteristics during operating time in such a way that correlations between the detected wheel-force component and the actual engine torque may be derived from them with ever-increasing accuracy.

An additional subsystem which is of fundamental importance for the operation of a motor vehicle is the brake system. It is readily possible to determine from the detected wheel-force component or wheel torque a braking torque exerted on the wheel by a brake which cooperates with that wheel. So in this case a detected wheel torque itself is used as an actual operating variable.

The evaluation of the functionality of a motor vehicle subsystem may be carried out in a particularly simple manner by having the evaluation device compare the determined actual operating variable to a target operating variable. The accuracy of this evaluation may be increased further by having the evaluation device determine a value for the deviation of actual from target from the comparison of the target and actual operating variables and compare this deviation of actual from target to a predetermined threshold value. After all, it is simpler to specify a critical deviation of actual from target in advance as the threshold value which, when it is exceeded, a malfunction of the system in question is to be evaluated. This also makes it possible to allow a deviation tolerance between the target and actual operating variables.

For maximum reliability of the monitoring, precise knowledge not only of the actual operating variable but also of the target operating variable is of great importance. For that reason, according to an advantageous refinement, the system also has a driver intervention sensor. The evaluation device is then able to determine the target operating variable from an output signal of the driver intervention sensor. Such a driver intervention sensor may be for example a pedal travel sensor, which detects an amount by which a gas pedal or brake pedal is depressed, or it may be a steering angle sensor, which detects rotation of the steering wheel or of the steering column.

Should monitoring of the subsystem of the motor vehicle by the system according to the present invention show that the subsystem which is to be monitored is functioning incorrectly, according to one aspect of the invention the driver may be informed thereof by an optical and/or acoustic and/or tactile and/or other warning signal. However, to ensure maximum possible traffic safety, it is advantageous for the evaluation device to output a control signal according to the result of the evaluation, and for the system to also include a control device that influences an operating condition of the motor vehicle according to the control signal.

Since such influencing of the operating condition of the motor vehicle normally takes the form of braking and/or an engine intervention, such as may be executed for example by ESP, antilock brake systems and traction control systems, the design complexity to implement the system according to the present invention may be reduced if the control device, and possibly also the evaluation device, is or are associated with a device for controlling and/or regulating the handling properties of a motor vehicle, such as an ESP system, an antilock brake system and/or a traction control system. Here “being associated” should include the possibility that the control device, and possibly the evaluation device is or are part of an ESP system, traction control system or antilock brake system.

The advantages named above may also be obtained from a system for error recognition in a motor vehicle having at least one tire and/or one wheel, where a force sensor is attached to the tire and/or to the wheel, in particular to the wheel bearing, and depending on the output signals from the force sensor a wheel torque variable representing the wheel torque is determined, and this wheel torque variable is compared to a torque variable derived from the engine output torque and/or to a braking variable representing the wheel braking torque, and the result of the comparison is used to recognize errors.

The present invention builds on the generic method in such a way that a wheel-force component of at least one wheel of the motor vehicle which acts essentially between the driving surface and the tire contact area is detected as the at least one operating parameter. In this way the advantages of the system according to the present invention are implemented in the method. This method is therefore especially well suited for use on one of the embodiments of the system according to the present invention named earlier. The advantages and peculiar features of the corresponding system embodiments are also contained in the embodiments of the method indicated below. For additional explanation of the method according to the present invention, reference is therefore made to the description of the system according to the present invention.

The method according to the present invention may be refined advantageously by having the evaluation step include determining the wheel torque acting on the particular wheel on the basis of the at least one wheel-force component detected by the wheel-force sensor device.

It is particularly beneficial in this case if a circumferential wheel-force and/or a wheel torque which retards or accelerates the particular wheel is detected directly in the detection step.

For reasons of simplicity of calculation, when monitoring a drive system an engine torque delivered by the engine is preferably determined as an actual operating variable. To further increase the accuracy of the determination, transmission losses of at least one torque transmission device in the torque transmission path from the engine to the wheel may be taken into account.

In addition, if the subsystem to be monitored is a brake system of the motor vehicle, a braking torque exerted on the wheel by the brake may be determined from the detected wheel-force component as an actual operating variable with little computing effort.

A simple variant of an evaluation of the functional readiness of the subsystem from an actual operating variable is the comparison of the determined actual operating variable to a target operating variable.

It is especially advantageous here if the comparison is independent of the particular actual and target operating variable values, so that the method advantageously includes determining the deviation of the actual value from the target value from processing the target and actual operating variables, as well as comparing this target-actual deviation to a predetermined threshold value.

In principle, the target operating variable may be predefined by a predetermined value or a predetermined characteristic curve. But in addition the driver may also choose to activate a driver intervention means, for example a pedal. The target operating variable may then be determined from the detected activation of the driver intervention means.

To increase traffic safety, the method may also include an additional step, namely influencing an operating condition of the motor vehicle according to the result of the evaluation.

The operating condition of the motor vehicle may be influenced in a particularly simple manner on the basis of the evaluation result if the influencing of an operating condition of the motor vehicle is carried out by a device for controlling and/or regulating the handling properties of a motor vehicle, such as an ESP system, an antilock brake system and/or a traction control system.

### DRAWING

The present invention is explained in greater detail below on the basis of the associated drawing.

FIG. 1 shows a block diagram of a system according to the present invention;

FIG. 2 shows a flow chart of a method according to the present invention;

FIG. 3 shows part of a tire equipped with a tire sidewall sensor;

FIG. 4 shows exemplary signal responses of the tire sidewall sensor depicted in FIG. 3;

FIG. 5 shows an alternative embodiment of a system according to the present invention;

FIG. 6 shows a circuit diagram in principle for evaluation of the functional readiness of the engine of the motor vehicle.

### DESCRIPTION OF THE EXEMPLARY EMBODIMENTS

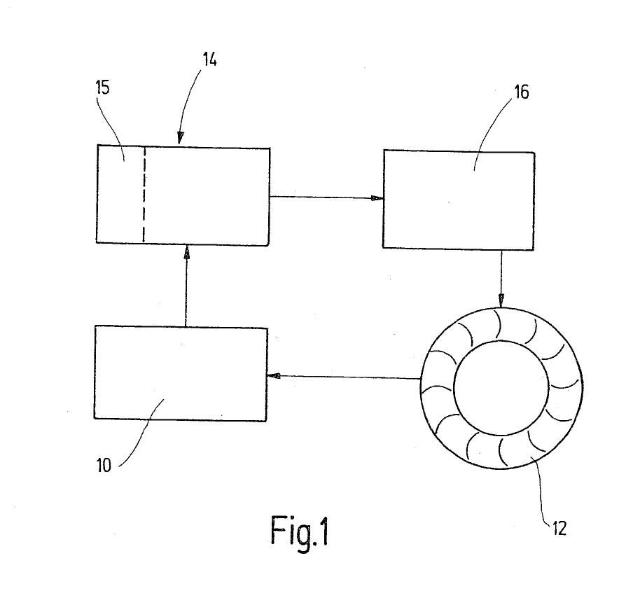

FIG. 1 shows a block diagram of a system according to the present invention. A sensor device 10 is associated with a wheel 12, depicted wheel 12 being shown as representative of the wheels of a vehicle. Sensor device 10 is connected to an evaluation device 14 for processing signals from sensor device 10. Evaluation device 14 includes a memory device 15 for storing detected values. In addition, evaluation device 14 is connected to a control device 16. This control device 16 in turn is associated with wheel 12.

In the example shown here, sensor device 10 detects the tire contact force of wheel 12. Sensor device 10 could also detect the transverse tire force of wheel 12. The results of this detection are conveyed to evaluation device 14 for further processing. For example, the tire contact force is determined in evaluation device 14 from a detected deformation of the tire. This may be accomplished by using a characteristic curve stored in memory unit 15. In evaluation device 14, a drive torque of the engine or a braking torque of a brake may then also be determined from the tire contact force. This signal may be transmitted to control device 16, so that influence may be exerted on the operating condition of the vehicle, in particular on wheel 12, depending on the signal. Such an influence may take place through an engine intervention and/or a brake intervention. According to one aspect of the present invention, the engine power may be influenced by adjusting the ignition timing and/or by changing the throttle valve setting and/or by selective suppressing injections.

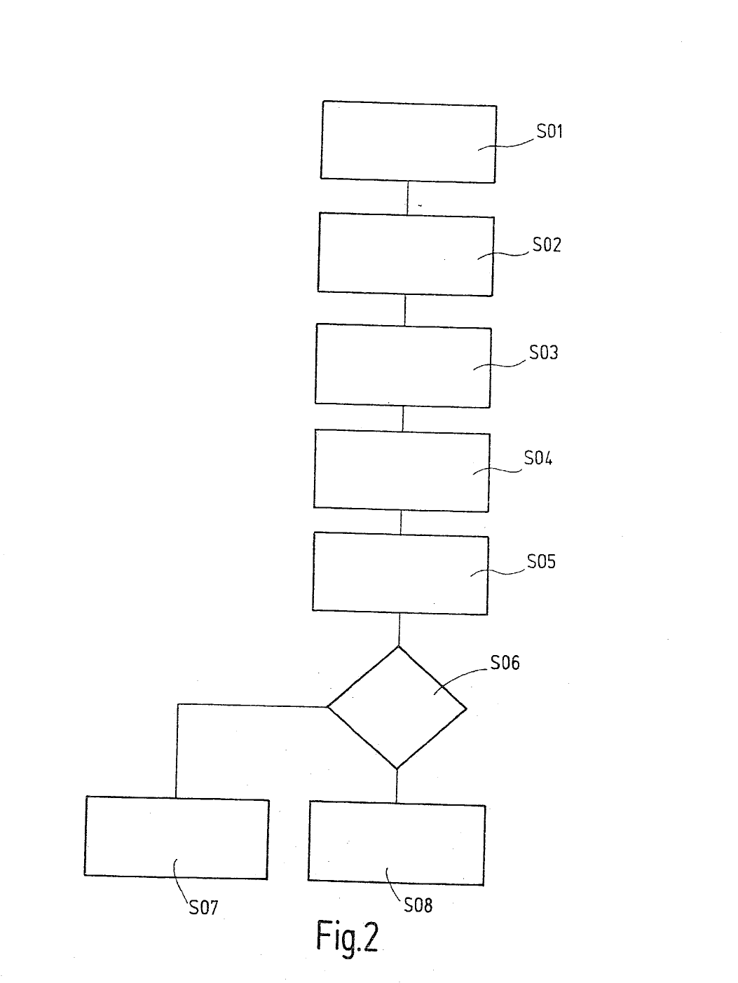

FIG. 2 shows a flow chart of an embodiment of the method according to the present invention within the framework of the present invention, depicting an evaluation of the functionality of the drive system of the motor vehicle. First, the meanings of the individual steps will be indicated:

S01: Detection of a deformation in the radial or circumferential direction of a tire.

S02: Determining a circumferential force of the tire on the driving surface from the detected deformation.

S03: Determining an actual engine torque as an actual operating variable of the engine from the determined circumferential force.

S04: Detection of a position of the gas pedal of the vehicle.

S05: Determining a target engine torque from the detected gas pedal position.

S06: Comparison of the determined actual engine torque to the determined target engine torque.

S07: Evaluation of the drive system as working correctly.

S08: Evaluation of the drive system as defective.

The procedure shown in FIG. 2 may be carried out in this way or similarly either with a rear-wheel-drive or a front-wheel-drive vehicle. In Step S01 for example, a deformation of a tire is measured in the radial or circumferential direction.

From this deformation, in Step S02 a circumferential wheel-force is determined. This may be done using a characteristic curve stored in a memory device, which gives the correlation between deformation in the radial or circumferential direction and the circumferential wheel-force.

In Step S03 an actual engine torque being delivered at present by the engine is determined from the circumferential wheel-force. This is done advantageously by taking into account the losses which occur during transmission of the engine torque from the engine to the driven wheels.

In step S04, the angle of depression of the gas pedal is detected. In step S05, a target engine torque requested by the driver is determined from the detected angle of depression.

In step S06, the determined actual engine torque and the determined target engine torque are compared with each other. If the actual engine torque does not exceed the target engine torque, in step S07 the drive system is evaluated as working correctly. However if the actual engine torque exceeds the target engine torque, in step S08 the drive system is evaluated as defective. Should an error in the drive system be determined in the evaluation, then the driver may be informed by a warning signal and the vehicle may be brought gradually to a standstill for reasons of safety. In addition, a process of analysis may follow, which seeks the source of the error in the drive system.

Monitoring of the brake system may take place by analogy to the above procedural description.

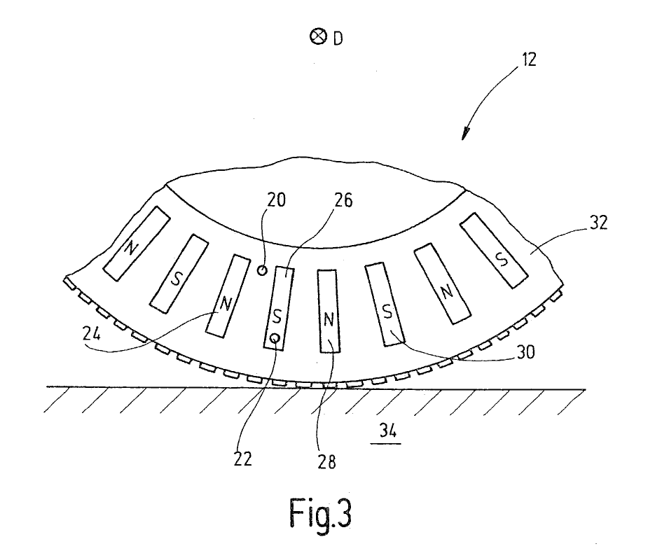

FIG. 3 shows a section of a tire 32 mounted on wheel 12, having a tire sidewall sensor device 20, 22, 24, 26, 28, 30 viewed in the direction of the axis of rotation D of tire 32. The tire sidewall sensor device includes two sensor devices 20, 22, attached firmly to the vehicle body at two different points in the direction of rotation. Sensor devices 20, 22 also each have a different radial distance from the axis of rotation D of wheel 32. In the example shown, sensor device 20 is positioned closer to the axis of rotation of wheel 12 than sensor device 22. The sidewall of tire 32 is provided with a plurality of magnetized areas functioning as transducers 24, 26, 28, 30 (strips) running essentially in the radial direction with reference to the rotational axis of the wheel, preferably having field lines running in the circumferential direction. The magnetized areas have alternating magnetic polarities.

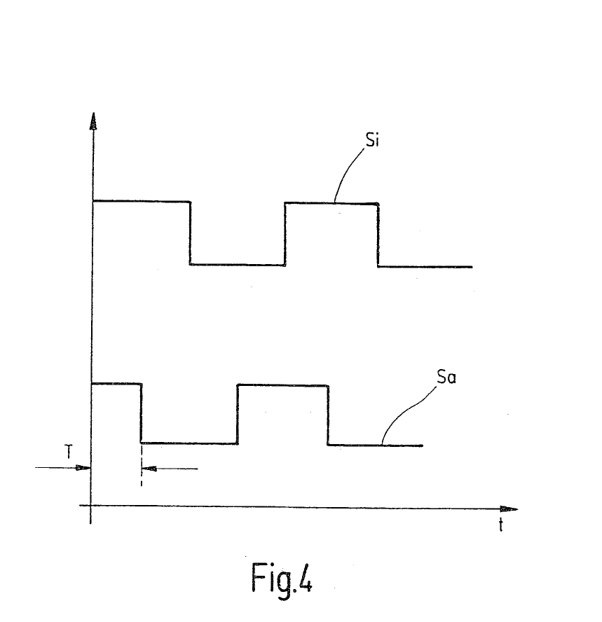

FIG. 4 shows the curve of signal Si of sensor device 20 from FIG. 3, located inside, i.e., closer to the axis of rotation of wheel 12, and of signal Sa of sensor device 22 from FIG. 3, located outside, i.e., farther away from the axis of rotation D of wheel 12. The rotation of tire 32 is recognized from the changing polarity of measurement signals Si and Sa. From the extent of roll-off and the change of the signals Si and Sa over time it is possible for example to calculate the wheel speed. Phase shifts T between the signals enable determination of deformations in tire 32, and thus for example direct detection of wheel-forces. Within the framework of the present invention it is of particular advantage if forces acting in the circumferential direction of tire 32 or a wheel torque retarding or accelerating wheel 12 can be determined directly. The currently acting engine or braking torque may be deduced from this wheel torque, making it possible to check or monitor the correctness of operation of the drive system or brake system.

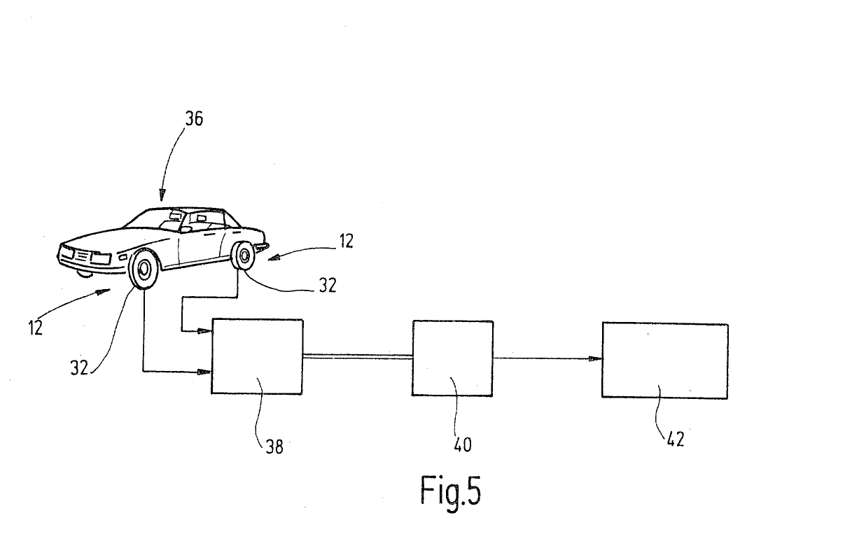

FIG. 5 shows an alternative embodiment of the system shown in FIG. 1. A vehicle 36 having tires 12 includes a tire control device 38. This tire control device communicates through an interface (for example CAN) with an engine management system 40 (for example ME7 or Cartronic). An interface is in turn provided between this engine management system 40 and a unit 42 which for example represents the engine, transmission and brakes of vehicle 36. Positioned in or on each of tires 32 of wheels 12 is a tire/sidewall sensor device of FIG. 3, which detects on each tire a force acting in the circumferential direction of wheel 12 or a wheel torque accelerating or retarding wheel 12. There is also an interface between this tire/sidewall sensor device and tire control device 38.

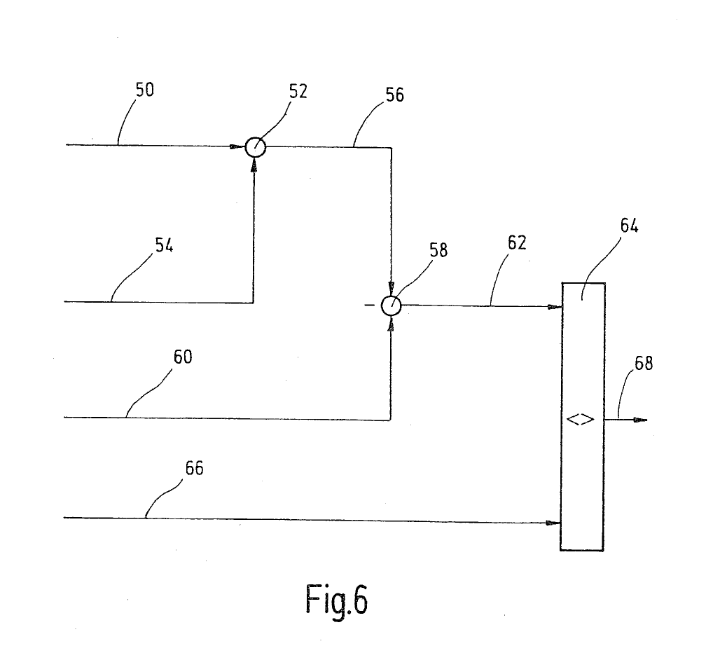

FIG. 6 shows a system circuit diagram for evaluating an error response on the basis of a detected wheel torque. A target engine torque determined via a gas pedal sensor is transmitted to a subtracter 52 over signal path 50. The gas pedal sensor detects the angular position or depression position of the gas pedal by the driver, from which the target engine torque is determined. Clutch and gear losses are transmitted to subtracter 52 via signal path 54. As the output signal of signal path 56, subtracter 52 supplies a target engine torque less the clutch and gear losses, which in this case essentially corresponds to a target wheel torque. This target wheel torque is transmitted to a subtracter 58, which receives the wheel torque detected by the wheel-force sensor device via signal path 60. From the subtraction of the target wheel torque and the detected actual wheel torque, subtracter 58 produces a target-actual difference, and transmits this along a signal path 62 to a comparison circuit 64. Comparison circuit 64 receives via signal path 66 a predefined threshold value, which it compares to the target-actual difference of signal path 62 to evaluate the functionality of the drive system. If the target-actual difference exceeds the predefined threshold value, comparison circuit 64 outputs an error signal on signal path 58; if the target-actual difference does not exceed the predefined threshold value, comparison circuit 64 does not output an error signal.

The brake system may be monitored similarly. Since as a rule no other or only negligible transmission losses occur between brake disk and wheel, signal paths 50, 54 and subtracter 52 are dispensable. In this case a target braking torque is transmitted over signal line 56 to subtracter 58 as the target wheel torque. Subtracter 58 produces from the target wheel torque and the actual wheel torque of signal path 60 a target-actual difference, and outputs it via signal path 62 to comparison circuit 64, which compares it to a possibly different predetermined threshold value of signal path 66. Again comparison circuit 64 outputs an error signal on signal path 68, depending on the result of the comparison.

It should be obvious to those skilled in the art that instead of a reduction of the engine torque and a comparison of target wheel torque and actual wheel torque at subtracter 58, the detected wheel torque of signal path 60 may also first be increased by the clutch and gear losses at an adder and then be compared as an actual engine torque to a target engine torque.

The preceding description of the examples of embodiments according to the present invention is intended only for purposes of illustration, and not to limit the invention. Various changes and modifications are possible within the framework of the present invention, without going outside of the scope of the invention and its equivalents.

What is claimed is:

1. A system for monitoring a motor vehicle subsystem (42) which enables the vehicle velocity to be influenced, the system comprising an evaluation device (14) that determines an actual operating variable of the subsystem (42) according to at least one operating parameter of the vehicle (36), and evaluates the functionality of the subsystem (42) to be monitored on the basis of the determined actual operating variable, wherein
at least one wheel-force sensor device (10) associated with a wheel (12) of the motor vehicle (36) is included, which detects at least one wheel-force component of the respective wheel (12) acting essentially between the driving surface and the tire contact area as the at least one operating parameter, and outputs a signal (Si, Sa) representing the wheel-force component; and
the evaluation device (14) determines the actual operating variable from the processing of the signal (Si, Sa) representing the wheel-force component.

2. The system as recited in claim 1, wherein the evaluation device (14) determines a wheel torque operating on the respective wheel (12) on the basis of the at least one wheel-force component detected by the wheel-force sensor device (10).

3. The system as recited in claim 1 or 2, wherein the at least one detected wheel-force component is a circumferential wheel-force and/or a wheel torque retarding and/or accelerating the respective wheel (12).

4. The system as recited in one of the preceding claims, wherein the wheel-force sensor device (10) is a tire sensor device (20, 22, 24, 26, 28, 30).

5. The system as recited in one of the preceding claims, wherein the wheel-force sensor device (10) is a wheel bearing sensor device.

6. The system as recited in one of the preceding claims, wherein the subsystem to be monitored (42) is a drive system (42) of the motor vehicle (36) and the actual operating variable is an engine torque delivered by the engine.

7. The system as recited in one of the preceding claims, wherein when determining an actual engine torque as an actual operating variable the evaluation device (14) takes into account transmission losses from at least one torque transmission device in the torque transmission path from the engine to the wheel (12).

8. The system as recited in one of the preceding claims, wherein the subsystem to be monitored (42) is a brake system (42) of the motor vehicle (36) and the actual operating variable determined by the evaluation device is a braking torque exerted by the brake on the wheel (12).

9. The system as recited in one of the preceding claims, wherein the evaluation device (14) compares the determined actual operating variable to a target operating variable.

10. The system as recited in one of the preceding claims, wherein the evaluation device (14) determines a target-actual deviation value from the comparison of the target and actual operating variables and compares this target-actual deviation value to a predetermined threshold value.

11. The system as recited in one of the preceding claims, wherein
a driver intervention sensor is also present, and
the evaluation device (14) determines the target operating variable from an output signal of the driver intervention sensor.

12. The system as recited in one of the preceding claims, wherein
the evaluation device (14) outputs a control signal according to the result of the evaluation, and
the system also includes a control device (16) that influences an operating condition of the motor vehicle (36) according to the control signal.

13. The system as recited in one of the preceding claims, wherein the control device (16), and, if appropriate, also the evaluation device (14), is or are associated with a device (40) such as an ESP system, an antilock brake system and/or a araction control system, for controlling and/or regulating the handling properties of a motor vehicle.

14. A system for error recognition in a motor vehicle having at least one tire (32) and/or one wheel (12), where a force sensor (20, 22, 24, 26, 28, 30) being mounted in the tire (32) and/or on the wheel (12), in particular on the wheel bearing, and, depending on the output signals (Si, Sa) of the force sensor (20, 22, 24, 26, 28, 30), a wheel torque variable representing the wheel torque is determined, and this wheel torque variable is compared
to a torque variable derived from the engine output torque and/or
to a braking variable representing the wheel braking torque, and the result of the comparison is used for error recognition.

15. A method for monitoring a motor vehicle subsystem which enables the vehicle velocity to be influenced, preferably to be carried out by a system according to one of claims 1 through 14, the method comprising the following steps:
detection (S01) of at least one operating parameter of the vehicle;
determination (S03) of an actual operating variable of the subsystem (42) according to the detected operating parameter of the vehicle (36); and
evaluation (S02, S07, S08) of the functionality of the subsystem (42) on the basis of the determined actual operating variable,
wherein a wheel-force component of at least one wheel (12) of the motor vehicle (36), acting essentially between the driving surface and the tire contact, area is detected as the at least one operating parameter.

16. The method as recited in claim 15, wherein the evaluation step (S02, S07, S08) includes determining (S02) the wheel torque operating on the respective wheel (12) on the basis of the at least one wheel-force component detected by the wheel-force sensor device (10).

17. The method as recited in claim 15 or 16, wherein in the detection step (S01) a circumferential wheel-force and/or a wheel torque retarding or accelerating the respective wheel (12) is detected.

18. The method as recited in one of claims 15 through 17, wherein the subsystem to be monitored (42) is a drive system (42) of the motor vehicle (36) and an engine torque delivered by the engine is determined (S03) as an actual operating variable.

19. The method as recited in one of claims 15 through 18, wherein when determining (S03) an actual engine torque as an actual operating variable, transmission losses from at least one torque transmission device in the torque transmission path from the engine to the wheel (12) are taken into account.

20. The method as recited in one of claims 15 through 19, wherein the subsystem to be monitored (42) is a brake system (42) of the motor vehicle (36), and a braking torque exerted by the brake on the wheel (12) is determined as an actual operating variable.

21. The method as recited in one of claims 15 through 20, wherein a comparison (S06) of the determined actual operating variable to a target operating variable is included.

22. The method as recited in one of claims 15 through 21, wherein determining a target-actual deviation value from a processing of the target and actual operating variables and comparing this target-actual deviation value to a predefined threshold value are included.

23. The method as recited in one of claims 15 through 22, wherein
actuation of a driver intervention means by the driver is also detected (S04), and
the target operating variable is determined from the detected actuation of the driver intervention means (SO5).

24. The method as recited in one of claims 15 through 23, wherein the following step is also included:
influencing an operating condition of the motor vehicle according to the result of the evaluation.

25. The method as recited in one of claims 15 through 24, wherein the influencing of an operating condition of the motor vehicle is carried out by a device (40) for controlling and/or regulating the handling properties of a motor vehicle, such as an ESP system, an antilock brake system and/or a yraction control system.
